(19) United States
(12) Patent Application Publication
(10) Pub. No.: US 2004/0101612 A1
(43) Pub. Date: May 27, 2004

(54) Salt whey product and method of making

(75) Inventor: Vikram V. Mistry, Brookings, SD (US)

Correspondence Address: MERCHANT & GOULD PC, P.O. BOX 2903, MINNEAPOLIS, MN, 55402-0903, US

(73) Assignee: South Dakota State University

(21) Appl. No.: 10/306,114

(22) Filed: Nov. 27, 2002

(51) Int. Cl. A23C 19/00

(52) U.S. Cl. 426/582

(57) ABSTRACT

A process for the manufacture of a salt whey product is provided. In the dried form the product contains 35-45% salt and 5-15% whey protein and in the liquid form, over 12% salt and over 30% solids. The salt whey product can be used as an ingredient in the manufacture of process cheese products and other food products. The salt whey product provides important functional and nutritional attributes from whey proteins.

The development of this invention was partially supported by funding for a HATCH project from the United States Department of Agriculture, project number SD000101-H. The Government may have certain rights in this invention.

### FIELD OF THE INVENTION

The invention relates to the recovery and reuse of salt whey from cheesemaking as a salt substitute and whey protein source in food processing.

### BACKGROUND OF THE INVENTION

Salt is a common ingredient in most cheese varieties. The amount in the finished cheese varies from 0.5 to 4.5% depending on variety. Salt serves several important functions in cheese, including flavor development and control, texture development, control of microbial growth, and optimization of the keeping quality of cheese. Approximately 35 to 50% of the salt added during cheese making is retained in the curd. The rest is expelled via salt whey, which contains 6% or more salt.

There are three main ways of salting cheese depending on the variety of cheese (Kosikowski, F. V., and V. V. Mistry. 1999. Cheese and Fermented Milk Foods. Vol 1. Origins and Principles. Rev 3^{rd} ed. F. V. Kosikowski LLC, Great Falls, Va.). Dry salt can be added to curd prior to pressing, cheese blocks can be immersed in brine, or salt can be applied to the surface of the cheese. A combination of one or more of these methods can also be used.

In the first method curd is salted after proper pH has been reached. The salted curd is then placed in hoops and pressed to form blocks. This method is used for cheese varieties such as Cheddar. The added dry salt induces the expulsion of whey from the curd. A part of the added salt is dissolved in this whey. This whey, called salt whey, contains 6% or more salt (Wendorff, W. 1996. Good salt management in cheese plants. UW Dairy Alert. 18 Nov. Univ. Wisconsin-Madison Coop. Extension). Therefore, the portion of added salt that is actually retained in curd is 35 to 50% and the rest is expelled via salt whey as waste.

Salt as a waste product is a potentially toxic substance because of its high chloride content. Environmental regulations therefore limit disposal of such products. For example, in Wisconsin the chloride limit in wastewater discharge from dairy plants is 395 mg/L. Salt whey at 6% salt (NaCl) contains approximately 36,400 mg/L. Salt whey is a problem for the cheese industry because it cannot readily be discarded, and no applications have been developed that can effectively convert the waste to a useful product.

The retention of salt in curd during dry salting is influenced by salting rate (Sutherland, B. J. 1974. Control of salt absorption and whey drainage in Cheddar cheese manufacture. Aust. J. Dairy Technol. 29:86-93.), curd temperature (Breene, W. M., N. F. Olson and W. V. Price. 1965. Salt absorption by Cheddar cheese curd. J. Dairy Sci. 48:621-624.), moisture content, pH and size of curd at salting (Gilles, J. 1976. Control of salt in moisture levels in Cheddar cheese. N. Z. Dairy Sci. Technol. 11:219-221.), and extent of mixing of salt and curd during salting as well as other factors. While the cheese maker can readily adjust one or more of these factors to increase the retention of salt in curd and therefore reduce the losses of salt as waste, the production of salt whey cannot be prevented. Brine salting instead of dry salting does not alleviate the problems caused by salt-containing waste products because of the need for large brining tanks and handling of spent brine.

Various disposal techniques for salt whey are presently used. 75% of salt whey is spread on land (Wendorff, W. 1996. Chloride regulation update. UW Dairy Pipeline. 8(2): 9). However, the emergence of stricter environmental guidelines makes this method of disposal undesirable. Also, if applied incorrectly, such a practice can cause crop damage because of the high chloride content of salt whey. Treatment of large volumes of salt whey in municipal wastewater plants may also cause chloride overload.

In a pollution-prevention effort a cheese manufacturer saved $12,500 annually when it reduced salt whey production by 75%. In this program the Frigo Cheese Corporation of Oconto Falls, Wis. developed ways of reducing salt whey and recovering it (Anon. 1995. Frigo Cheese Corporation. Salt whey recovery/reuse by evaporation. Pub1-SW-167. Bureau of Cooperative Environmental Assistance, WI Dept., Natural Resources, Madison, Wis.). Before commencing the program, the company produced 900 kilograms of salt whey per day. This was reduced to 225 kilograms per day by evaporation and reusing salt whey in cheese processing.

Cheddar cheese typically contains 1.5 to 1.8% salt but the amount actually added to curd is 2 to 3%. During Cheddar cheese making, curd looses 12 to 16% of its weight as salt whey between salting and removal from the hoop after pressing is completed. Hence, for every 1,000 kg of Cheddar cheese produced, approximately 150 to 200 kg of salt whey is generated. This whey contains 9 to 12 kg of salt. Annually in the U.S. alone, approximately 1.2 billion kilograms of Cheddar cheese is produced, which forms almost a third of the total cheese production in the U.S. This quantity of cheese amounts to a loss of over 10 to 14 million kg of salt. The environmental impact of this is also significant. Effective disposal methods for salt-containing waste products, new techniques to minimize the losses of salt, or new ways to utilize salt whey are therefore needed.

### SUMMARY OF THE INVENTION

The invention relates to methods of making an edible salt whey product by removal of fat from salt whey, pasteurizing the skimmed salt whey, and thermal evaporation of the pasteurized salt whey. The invention also relates to dried salt whey products containing 5-15% whey protein, 35-45% salt, 35-45% lactose, and 1-3% fat, and liquid salt whey products containing 1-5% whey protein, 5-20% salt, 5-15% lactose, and 0-2% fat.

### BRIEF DESCRIPTION OF THE DRAWINGS

FIG. 1 illustrates the steps involved in producing a salt whey product according to one embodiment of the invention.

### DETAILED DESCRIPTION OF THE INVENTION

As used herein, the term “about” applies to all numeric values, whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

As used herein, “whey” is intended to mean any liquid by-products from the cheesemaking process, and “salt whey” refers to whey expressed from the curd after salting. As used herein, “salt” is intended to mean sodium chloride and/or potassium chloride.

In addition to salt, the salt whey expressed during cheesemaking contains protein and calcium. The protein in liquid milk includes casein and whey protein. Most of the casein in the liquid milk used in cheesemaking remains in the cheese. However, some casein may be present in the salt whey. As used herein, “whey protein” is intended to include any protein found in the liquid by-products from cheesemaking.

The nutritional and functional value of whey proteins makes them useful as food ingredients. Whey proteins include beta-lactoglubulin, alpha-lactalbumin, lactoferrin, lactoperoxidase, serum albumin and immunoglobulins. Whey proteins and calcium have been shown to have many health benefits. Adding a product containing salt, whey proteins and calcium instead of just salt in food processing would provide additional nutritional benefits to the food product.

As used herein, “pasteurization” is intended to mean any treatment that destroys objectionable organisms without significant chemical alteration of the substance being treated. Pasteurization generally involves heating a product to a particular temperature and holding the product continuously at or above a particular temperature for at least a particular time period.

In the United States, the Food and Drug Administration regulates pasteurization conditions that must be used for commercial food products. The regulations for milk and milk products are set forth in 21 C.F.R. § 1240.61. Examples of acceptable heating procedures include heating to at least 63° C. (145° F.) for at least 30 minutes, heating to at least 71° C. (161° F.) for at least 15 seconds, heating to at least 89° C. (191° F.) for at least 1 second, heating to at least 90° C. (194° F.) for at least 0.5 second, heating to at least 94° C. (201° F.) for at least 0.1 second, heating to at least 96° C. (204° F.) for at least 0.05 second, and heating to at least 100° C. (212° F.) for at least 0.01 second. The regulations set forth additional requirements for products with a fat content of 10% or more and for products with added sweeteners. Ultrapasteurized products are heated at or above 280° F. for at least 2 seconds. Additionally, the regulations state that any other pasteurization process can be used if it is recognized by the Food and Drug Administration to be equally efficient in the destruction of microbial organisms of public health significance. Acceptable pasteurization conditions may vary for different countries.

Method

A method of making a salt whey product involves separating (or skimming) salt whey, followed by pasteurization, evaporation, and drying. It will be understood that the exact conditions and equipment used to carry out the separation, pasteurization, evaporation and drying steps may be adjusted for a particular processing plant.

1. Separation

Fat is removed from the salt whey by centrifugal separation, skimming, or microfiltration. Microfiltration can also be used to remove residual casein from the salt whey. The separation method can be selected and adjusted to achieve a desired fat content in the separated salt whey. Multiple different separation methods, and/or multiple repeats of a single separation method can also be used to achieve a desired fat content. The fat content in the separated salt whey is generally less than 2%, preferably less than 1%, more preferably less than or equal to 0.5%. Alternatively, for final products in which any percentage of fat is acceptable, the separation step can be eliminated.

2. Pasteurization

Separated salt whey is pasteurized under any acceptable pasteurization conditions. A standard pasteurization step involves heating the salt whey to 63° C. for 30 minutes. High Temperature Short Time (HTST) pasteurization involves heating at 71.7° C. for 15 seconds. If evaporation does not commence immediately, the separated, pasteurized salt whey is stored at or below 4° C. Additional treatment steps can be carried out on the salt whey to obtain a product with specific characteristics. For example, whey proteins can be denatured by heating the salt whey to 93° C. for 3 to 4 minutes. When a colorless salt whey product is desired, the separated salt whey can be decolorized by adding bleaching agents known in the food processing industry.

3. Concentration

Pasteurized salt whey can be concentrated by thermal evaporation or reverse osmosis. Nanofiltration or ultrafiltration can also be used if the salt concentration is to be lowered prior to concentration. Final products without casein can be obtained by subjecting the salt whey to microfiltration to remove the casein prior to concentration. Thermal evaporation is performed using standard evaporators known in the dairy processing industry. The solids content of the concentrated salt whey is preferably from 20-35%.

4. Drying

Concentrated salt whey can be dried when a powdered product is desired. When a liquid product is desired, the pasteurized concentrated salt whey is stored at or below 4° C. Concentrated salt whey can be dried by spray drying, roller drying or drum drying. Spray drying involves atomizing the concentrated salt whey into a hot air stream at about 180°-200° C. Spray drying may involve fluidization and/or instantization. Fluidization can involve a static fluid bed integrated in the base of the spray drying chamber, and/or an external vibrating fluid bed. Instantization, generally achieved by agglomeration, increases the amount of air incorporated between powder particles, and results in a powder with improved reconstitution properties such as wettability, sinkability, dispersibility and solubility. Instantization can be carried out either during the drying process or after the powder is dried. The dried salt whey preferably has a moisture content of not more than 5%. The dried salt whey product, in which fat is removed by separation and in which nanofiltration is not used for concentration, generally has a salt content of 35 to 45%.

Applications

The salt whey product has broad applications in food processing. The salt whey product can be added to virtually any food product to which salt is added during processing. Using the salt whey product in food processing has several advantages over the use of salt alone. The salt whey provides added nutrients such as whey proteins and calcium. The powdered salt whey may also act as a thickener, reducing the amount of thickeners necessary, which often provide no nutritional value. As a powder, the salt whey product is easily incorporated into many different food processing methods. The powdered salt whey is easily stored and shipped. The salt whey product also has application as a dried or liquid edible consumer-usable salt substitute.

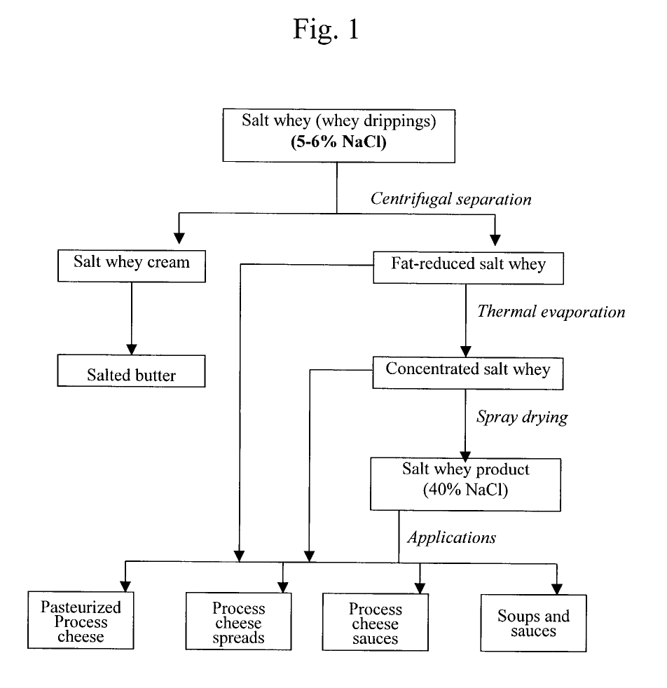

The salt whey product has particular application in the production of cheese and cheese-containing products, such as process cheese and cheese-containing spreads and sauces. Specific applications evaluated for the salt whey product were for the manufacture of pasteurized process cheese, process cheese spreads and sauces. Process cheeses were manufactured according to published procedures (Kosikowski, F. V., and V. V. Mistry. 1999. Cheese and Fermented Milk Foods. Vol 2. Procedures and Analysis. Rev 3^{rd} ed. F. V. Kosikowski LLC, Great Falls, Va.) using a single-auger direct steam injection cooker (Model 84-062, Damrow, Fond du Lac, Wis.). The batch size of the process cheese ranged from 10 to 15 kg. A flow chart illustrating the method of producing the salt whey product and applications for the salt whey product is shown in FIG. 1.

Examples of applications of the salt whey product of the invention are described below but are not limited to such applications. Salt whey cream produced by the process of the invention contained a small portion of the salt. A 40% fat salt whey cream has approximately 3.5% salt, which can be applied in the manufacture of salted butter. Whey cream is currently used for butter manufacture. Salt whey cream made by a method of the invention can be blended with whey cream in the manufacture of salted butter.

The composition of salt whey product, especially the salt content, will vary from batch to batch, depending on the characteristics of the salt whey from which it is produced. In order to produce a salt whey product with a standard salt concentration, the salt content of the salt whey may have to be reduced or supplemented. Specific steps, such as nanofiltration or ultrafiltration, can be used to lower the salt content. Alternatively, concentrated salt whey, dried salt whey product, or dry salt can be added to increase the salt content to a target level or desired range.

### EXAMPLE 1

Dried Salt Whey Product

Three replicates of a method of making the salt whey product according to the invention were performed. Approximately 110 kg of salt whey was obtained for each replicate from a commercial cheese manufacturer. The salt whey had been removed from curd after the salted curd was placed in barrels for draining of the whey and curd fusion. The salt whey was maintained at approximately 2° C. until processing commenced.

Salt whey underwent centrifugal separation (DeLaval Separator Co., New York, N.Y.) at 35° C. to remove some of the fat. Separated salt whey was pasteurized at 63° C. for 30 minutes and cooled to 20° C., followed by evaporation. Thermal evaporation was conducted in a rising-film single-stage Blaw-Knox® evaporator (C. E. Rogers, Mora Minn.). Vapor temperature was 43° C. and vacuum was 635 mm Hg. Evaporation proceeded until the total solids content was approximately 22%.

Spray drying was performed in a single stage Niro Atomizer pilot plant spray drier (Model ASO 412/E, Columbia, Md.). The drier was equipped with a rotary atomizer, a propane-fired heater, and two exits for the powder (main powder collection and cyclone separator). The drying capacity was 16 to 18 kg of water per hour. The inlet air temperature was 200° C. and the outlet was maintained at 85 to 95° C. Powder from the main collection chamber and the cyclone was blended and stored at approximately 4° C. until needed for analysis and applications.

### EXAMPLE 2

Process Cheddar Cheese

Base cheddar cheese for manufacturing process cheeses was obtained from a commercial source in blocks of approximately 18 kg. The pasteurized process cheese formulation consisted of a blend of young (1 to 2 month old) and aged (4 to 6 month old) cheddar cheese in equal proportions. Targeted moisture content of the pasteurized process cheeses was 40 to 42%. Disodium phosphate duohydrate (Rhodia Food, Cranbury, N.J.) was used as the emulsifying salt at a rate of 3%. Four formulations were developed for this application. The first formulation consisted of a control pasteurized process cheese in which no salt whey product was added. This formulation is abbreviated CO. The second formulation was a control with no added salt whey product and no emulsifier. This formulation is abbreviated COE. In the third formulation, salt whey product was added at a rate of 2% such that the finished cheese contained approximately 42% moisture and 2% salt (NaCl). This formulation is abbreviated SW. In the fourth formulation the salt whey product was added at 1.7% but no emulsifier was added. This formulation is designated SWOE. The four formulations are listed in Table 1.

TABLE 1
Formulations for Process Cheddar cheese manufacture¹

| Ingredient | CO | C0E | SW | SW0E |
|---|---|---|---|---|
| Young Cheese (kg) | 5.72 | 6.19 | 5.63 | 6.03 |
| Aged Cheese (kg) | 5.72 | 6.19 | 5.63 | 6.03 |
| Anhydrous milk fat (butteroil) | 499.00 | 0 | 494.00 | 0 |
| (grams) | | | | |
| Disodium phosphate duohydrate | 422.20 | 0 | 422.20 | 0 |
| (grams) | | | | |
| Water (grams) | 474.10 | 54.00 | 475.00 | 217.00 |
| Salt (NaCl) (grams) | 109.90 | 86.60 | 0 | 0 |
| Salt Whey Product (grams) | 0 | 0 | 285.60 | 234.70 |
| Condensate² (kg) | 1.13 | 1.09 | 1.13 | 1.09 |

¹CO = Control; C0E = Control cheese with no added salt whey product or emulsifier; SW = Cheese with added salt whey product; SW0E = cheese with added salt whey product but no emulsifier.
²Derived due to direct steam injection

The general procedure for manufacturing this cheese was as follows: calculated quantities of young and aged cheddar cheeses were shredded and added to a cheese cooker in four portions. In between the portions of the shredded cheese, other ingredients (emulsifier, water, salt, and salt whey product where applicable) were added. Other ingredients that may be added to the process cheese at this stage include fats, vitamins, minerals, flavorings, or any other desired food ingredient. Culinary steam was injected and the temperature was brought up to 74° C. and held for 2 min. All cheeses were placed in approximately 2-kg containers, sealed and stored upside down at 4° C. immediately after packaging.

### EXAMPLE 3

Provolone Cheese Spread

For the cheese spread, a commercial provolone cheese was used. The targeted moisture content was 55% and two formulations were used. The first formulation was a control provolone cheese spread, abbreviated PCO. The second formulation was a provolone cheese spread containing salt whey product, abbreviated PSW. In both formulations 3% emulsifying salt was included and the targeted salt (NaCl) content of the finished cheese was 2%. Calculated amounts of provolone cheese were shredded and added to the cheese cooker. Other ingredients were then added and were followed by the injection of culinary steam. The temperature was raised to 74° C. and held for 2 min. The cheeses were then placed in 2-kg containers, sealed and immediately transferred to a room maintained at 4° C. The two formulations are listed in Table 2. Alternatively, liquid salt whey could be used instead of dried salt whey, with a corresponding reduction or elimination of the added water.

TABLE 2
Typical formulation for Provolone cheese spread manufacture¹

| Ingredient | PCO | PSW |
|---|---|---|
| Cheese (kg) | 9.34 | 8.87 |
| Anhydrous milk fat (butteroil) (grams) | 572.00 | 694.00 |
| Disodium phosphate duohydrate (grams) | 422.20 | 422.20 |
| Water (kg) | 2.51 | 2.70 |
| Salt (NaCl) (grams) | 94.50 | 0 |
| Salt Whey Product (grams) | 0 | 247.20 |
| Condensate² (kg) | 1.13 | 1.13 |

¹PCO = Control; PSW = cheese containing salt whey product.
²Derived due to direct steam injection

### EXAMPLE 4

Primavera Cheese Sauce

In the fourth example, the salt whey product was used to replace thickener and salt in a Primavera cheese sauce. This was accomplished by adding the salt whey product (approximately 8% by weight) to the sauce mix during cooking.

Analysis

The gross composition of cheeses was analyzed as follows. Moisture was measured by the oven method, fat and protein by the Association of Official Analytical Chemists International (AOAC) procedures, and sodium by atomic absorption (AOAC, Association of Official Analytical Chemists. 1997. Dairy Products. In P. Cunniff, Official Methods of Analysis. Vol 2 (16^{th} ed) pp 1-75. Gaithersburg, Md.). In addition, liquid products (salt whey and concentrated salt whey), and the salt whey product were also analyzed as above, except that the moisture content was determined by the Mojonnier method (Atherton, H. V., and J. A. Newlander. 1977. Chemistry and Testing of Dairy Products. 4^{th} ed. AVI Publ. Co. Westport, Conn.). Hardness of the pasteurized process cheeses was tested using a 75% compression two-bite test. Cylindrical (20 mm×20 mm) samples were used to obtain a force distance curve using a Universal testing machine (Model 2/D; MTS Sintech Inc., Research Triangle Park, N.C.). A 45.4 kg load cell was used at a crosshead speed of 50 mm/min. Cheese hardness was determined as the highest force recorded during the first cycle of compression (Prentice, J. H. 1992. Dairy Rheology: A Concise Guide. Pp 89-92. VCH Publ. Inc. New York, N.Y.). Melting characteristics of cheeses were determined using the Schreiber melt test (Kosikowski, F. V., and V. V. Mistry. 1999. Cheese and Fermented Milk Foods. Vol 2. Procedures and Analysis. Rev 3^{rd} ed. F. V. Kosikowski LLC, Great Falls, Va.). A 39 mm×5 mm disk of cheese was heated in an oven at 232° C. for 5 minutes and the diameter was measured after 30 minutes of cooling at room temperature. Free oil of the pasteurized process cheeses was analyzed using the modified Babcock method (Kindstedt, P. S., and J. K. Rippe. 1990. Rapid quantitative test for free oil (oiling off) in Mozzarella cheese. J. Dairy Sci. 73:867-873). Descriptive sensory evaluation of the cheeses was done by an experienced panel but a scorecard was not used.

Results

The composition of salt whey and the salt whey product is provided in Table 3.

TABLE 3
Composition of salt whey products

| | Total | | | | | |
|---|---|---|---|---|---|---|
| | Solids | Fat | Protein | Ash | Salt | Lactose¹ |
| Product | (%) | | | | | |
| Salt Whey | 12.61 | 0.82 | 1.26 | 5.48 | 5.10 | 5.04 |
| Separated Salt | 11.95 | 0.24 | 1.17 | 5.46 | 4.94 | 5.08 |
| Whey | | | | | | |
| Condensed Salt | 28.41 | 0.56 | 2.91 | 13.18 | 12.00 | 11.77 |
| Whey | | | | | | |
| Dried Salt Whey | 96.73 | 1.97 | 10.12 | 44.80 | 40.11 | 39.84 |
| (Salt Whey Product) | | | | | | |
| Salt Whey Cream | 75.47 | 70.97 | 0.96 | 1.67 | 1.43 | 1.87 |

¹Calculated by difference

The production of the salt whey product employs equipment that is standard to the dairy industry, i.e., separator, pasteurizer, evaporator and spray dryer. The salt whey used in the methods consisted of approximately 5% salt (NaCl). The final salt whey product consisted of approximately 40% salt. Because of the presence of large amounts of salt in salt whey, lactose forms a smaller component of the dry matter than it does in sweet whey. Sweet whey normally has approximately 70% lactose in the dry matter whereas in salt whey, lactose forms approximately 40% of the dry matter. Crystallization during evaporation and drying is therefore not a problem, so salt whey does not need to be pre-crystallized. This property of the salt whey product also provides flexibility in storage of the product at ambient temperatures. Minimum caking was noted during storage.

In Example 2, use of the salt whey product in the manufacture of pasteurized process cheese was demonstrated. The salt whey product is a source of salt, which is normally present in process cheeses, and of whey proteins, which are sometimes added to process cheeses to improve body and control melt properties. Process cheeses with added whey proteins are usually referred to as process cheese foods. Addition of up to 2% of the weight of the final process cheese resulted in a level of approximately 2% salt in the final cheese. At this rate, approximately 160 kg of salt whey are utilized per 1000 kg of process cheese produced. As shown below in Table 4, the addition of the salt whey product did not alter the composition of the cheese or its pH.

TABLE 4
Composition of pasteurized process cheeses made with salt whey product

| | Moisture | Fat | Protein | Ash | Salt | pH |
|---|---|---|---|---|---|---|
| Cheese¹ | (%) | | | | | |
| CO | 41.50 | 31.22 | 18.93 | 5.49 | 1.65 | 6.04 |
| C0E | 42.69 | 29.95 | 20.60 | 4.24 | 0.88 | 5.73 |
| SW | 41.96 | 30.11 | 18.56 | 5.28 | 1.66 | 6.14 |
| SW0E | 42.79 | 30.35 | 20.02 | 4.78 | 0.91 | 5.86 |

¹CO = control cheese; C0E = control cheese without emulsifier; SW = cheese made with salt whey product; SW0E = cheese made with salt whey product and without emulsifier.

The addition of the salt whey product improved the texture of the cheese by making it smoother. In the absence of emulsifier the process cheese with added salt whey product exhibited excellent stretch properties. Such cheese would be excellent for hot applications. The pH of cheeses without emulsifier was slightly lower than that with emulsifier and the salt whey product had no impact on pH. The melting quality of the cheeses with the salt whey product was excellent, though in the absence of emulsifier, there was a release of free oil during melting as would be expected by one of skill in the art (Table 5).

TABLE 5
Properties of pasteurized process
cheeses manufactured with salt whey product

| | Free oil | Hardness | Meltability |
|---|---|---|---|
| Cheese¹ | (%) | (kg) | (mm) |
| CO | 9.83 | 7.49 | 72.87 |
| C0E | 10.19 | 15.47 | 63.85 |
| SW | 8.04 | 8.56 | 70.07 |
| SW0E | 16.68 | 10.54 | 70.57 |

¹CO = control cheese; C0E = control cheese without emulsifier; SW = cheese made with salt whey product; SW0E = cheese made with salt whey product and without emulsifier.

The amount of free oil released by the emulsifier-free cheeses was slightly higher in those with added salt whey product than the control cheese. Previous studies demonstrated the application of whey proteins in process cheese to control the melt, but the amount of whey proteins added in this study was relatively small, so the impact on melting is probably negligible. Among cheeses with added emulsifier, the hardness was similar but in the absence of emulsifier, the cheeses with added salt whey product were softer than the controls. Previous studies demonstrated the softening effect of whey proteins on cheese.

In Example 3, the use of the salt whey product in the manufacture of a Provolone spread was demonstrated. The composition of the cheeses was similar to that of the control (Table 6) but with 2% salt whey product added, a portion of the salt was derived from it. The flowing characteristics and melting qualities of the cheese were excellent.

TABLE 6
Composition of Provolone spread manufactured with salt whey product

| | Moisture | Fat | Protein | Ash | Salt | pH |
|---|---|---|---|---|---|---|
| Cheese¹ | (%) | | | | | |
| PCO | 56.27 | 19.27 | 17.12 | 4.89 | 1.36 | 6.27 |
| PSW | 57.42 | 19.32 | 16.53 | 4.85 | 1.33 | 6.20 |

¹PCO = control cheese; PSW = cheese made with salt whey product.

In Example 4, the application of the salt whey product as an additive to cheese sauces such as Primavera sauce was illustrated. The salt whey product was the only source of salt in the sauce and served as a thickener and also provided flavor. Rate of addition of 8% provided adequate salt and thickening effect in the sauce.

The invention has been described with reference to various specific and illustrative embodiments and techniques. However, it should be understood that many variations and modifications may be made while remaining within the spirit and scope of the invention.

What is claimed is:

1. A method of making a salt whey product comprising:
providing salt whey;
removing fat from the salt whey;
pasteurizing the salt whey; and
concentrating the pasteurized salt whey.

2. The method of claim 1 wherein the step of removing fat is achieved by centrifugal separation.

3. The method of claim 1 further comprising a step of drying the concentrated salt whey.

4. The method of claim 3 wherein the dried salt whey product has a salt concentration of at least 30%.

5. The method of claim 1 wherein the concentrating step is carried out by thermal evaporation, reverse osmosis, nanofiltration or ultrafiltration.

6. The method of claim 1 wherein the concentrating step proceeds until the total solids content is 25 to 35%.

7. A dried composition comprising 5-15% whey protein, 35-45% salt, 35-45% lactose, and 1-3% fat, wherein said composition is in powder form.

8. A dried edible salt substitute comprising 35-45% salt and 5-15% whey protein.

9. The edible salt substitute of claim 8 further comprising 1-3% fat.

10. The edible salt substitute of claim 9 further comprising 35-45% lactose.

11. A liquid edible salt substitute made according to the method of claim 1, comprising at least 12% salt and at least 25% solids.

12. A foodstuff containing the composition of claim 7.

13. A foodstuff containing the salt substitute of claim 8.

14. A foodstuff containing the salt substitute of claim 11.

15. A method of providing a food product having a salty taste, comprising adding a dried salt whey product having 35-45% salt and 5-15% whey protein, to a food product in an amount effective to season the food product.

16. A method of making a process cheese product comprising:
combining cheese and a dried salt whey product to form a mixture, the salt whey product comprising 35-45% salt and 5-15% whey protein; and
pasteurizing the mixture.

17. The method of claim 16 wherein the step of pasteurizing involves bringing the temperature of the mixture to 65 to 75° C. and cooking the mixture for 30 seconds to 2 minutes.

18. The method of claim 16, wherein the salt whey product further comprises 35-45% lactose and 1-3% fat.

19. The method of claim 16, wherein the salt whey product is added at a rate of 1-3% by weight.
